(19) United States
(12) Patent Application Publication
(10) Pub. No.: US 2004/0124022 A1
(43) Pub. Date: Jul. 1, 2004

(54) Motor vehicle having at least one radiator and method of making a vehicle radiator assembly

(76) Inventors: Markus Schmid, Moensheim (DE); Dimitar Danev, Renningen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/661,773

(22) Filed: Sep. 15, 2003

(30) Foreign Application Priority Data
Sep. 14, 2002 (DE) 102 42 788.7

(51) Int. Cl. B60K 11/00

(52) U.S. Cl. 180/68.1

(57) ABSTRACT

A motor vehicle has at least one radiator which, on an input side, has a first air guiding duct with a cooling-air inlet opening and, on an output side, has a second air guiding duct with a cooling-air outlet opening. In order to be able to reduce the mounting expenditures and the fastening devices in the case of a radiator arrangement, it is provided that the at least one radiator is accommodated by a supporting frame fastened to the adjoining body, and in that an air guiding element is constructed in one piece with the supporting frame, which air guiding element, together with the radiator, forms at least one of the two air guiding ducts.

### BACKGROUND AND SUMMARY OF THE INVENTION

This application claims the priority of German Application No. 102 42 788.7 filed Sep. 14, 2002, the disclosure of which is expressly incorporated by reference herein.

The invention relates to a motor vehicle having at least one radiator which, on an input side, has a first air guiding duct with a cooling-air inlet opening and, on an output side, has a second air guiding duct with a cooling-air outlet opening.

In a known arrangement of the initially mentioned type (European Patent Document EP 0 213 387 A2, corresponding U.S. Pat. No. 4,673,206), a radiator is arranged in the forward structure of the motor vehicle, which radiator has a first air guiding duct on the input side and a second air guiding duct on the output side. On the forward-side end region, a cooling-air inlet opening is provided, and the second air guiding duct has a cooling-air outlet opening facing the road.

In this arrangement, the radiator and both air guiding ducts are formed by separate components which, each separately, are held by means of fastening elements in their position on the adjacent vehicle body. Such an arrangement has a relatively high-expenditure construction, and a large number of fastening elements are required.

It is an object of the invention to take such measures on a radiator arrangement provided with air guiding ducts that the mounting expenditures and the fastening devices are reduced.

According to one aspect of the invention, this object is achieved by providing a motor vehicle having at least one radiator which, on an air input side, has a first air guiding duct with a cooling-air inlet opening and, on an air output side, has a second air guiding duct with a cooling-air outlet opening, wherein at least one radiator is accommodated in a supporting frame fastened to an adjoining body, and wherein an air guiding element is constructed in one piece with the supporting frame, which air guiding element, together with the radiator, forms at least one of the first and second air guiding ducts.

Important advantages achieved by means of the invention are that, as a result of the arrangement of a two-part supporting frame for receiving the radiator, a fast and simple mounting of the cooler on the vehicle body is achieved. As a result of the integration of an air guiding element into the supporting frame, fastening elements for the exhaust-air-side air guiding duct are eliminated, and simultaneously, the supporting frame is effectively reinforced by the air guiding element. As a result of the arrangement of intermediate pieces between the top part and the bottom part of the supporting frame according to certain preferred embodiments of the invention, radiators of different heights can be accommodated in the supporting frame. In addition, the air guiding element provides a heat sealing toward the adjacent trunk recess.

Other objects, advantages and novel features of the present invention will become apparent from the following detailed description of the invention when considered in conjunction with the accompanying drawings.

### BRIEF DESCRIPTION OF THE DRAWINGS

FIG. 1 is a frontal view of a forward structure region of a passenger car having a preferred embodiment of the present invention;

FIG. 2 is a sectional view taken along Line II-II of FIG. 1;

FIG. 3 is a perspective frontal view of the supporting frame for the radiator shown in FIG. 2;

FIG. 4 is a perspective rear view of the top part of the supporting frame of FIG. 3;

FIG. 5 is a top view of the supporting frame of FIGS. 2 and 3;

FIG. 6 is an enlarged sectional view taken along Line VI-VI of FIG. 5;

FIG. 7 is an enlarged sectional view taken along Line VII-VII of FIG. 5; and

FIG. 8 is an enlarged sectional view taken along Line VIII-VIII of FIG. 5.

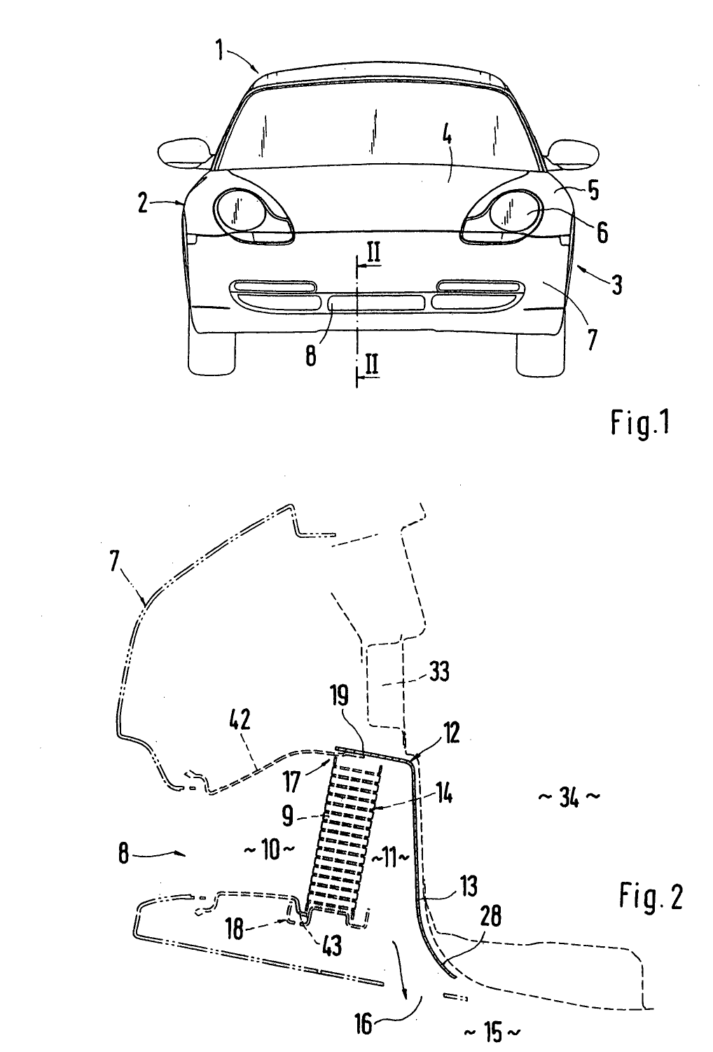

### DETAILED DESCRIPTION OF THE DRAWINGS

A motor vehicle formed as a passenger car 1 comprises a stationary body 2, which, in the illustrated forward structure region 3, has a forward hood 4, lateral fenders 5, headlight units 6 and a forward covering part 7 with a transversely extending cooling-air inlet opening 8.

The large-surface elastic covering part 7 is disposed in front of a dimensionally stable carrier of a bumper and is held in position in a conventional manner by screws, clips or the like at the adjacent body 2. In a bottom region of the covering part 7 which, viewed in the transverse direction, is in the center, at least one radiator 9 is arranged adjacent to the cooling-air inlet opening 8, for guiding the cooling-air flow acting upon the radiator 9, a first air guiding duct 10 being arranged in front of the radiator 10 and a second air guiding duct 11 being arranged behind the radiator 9 (FIG. 2).

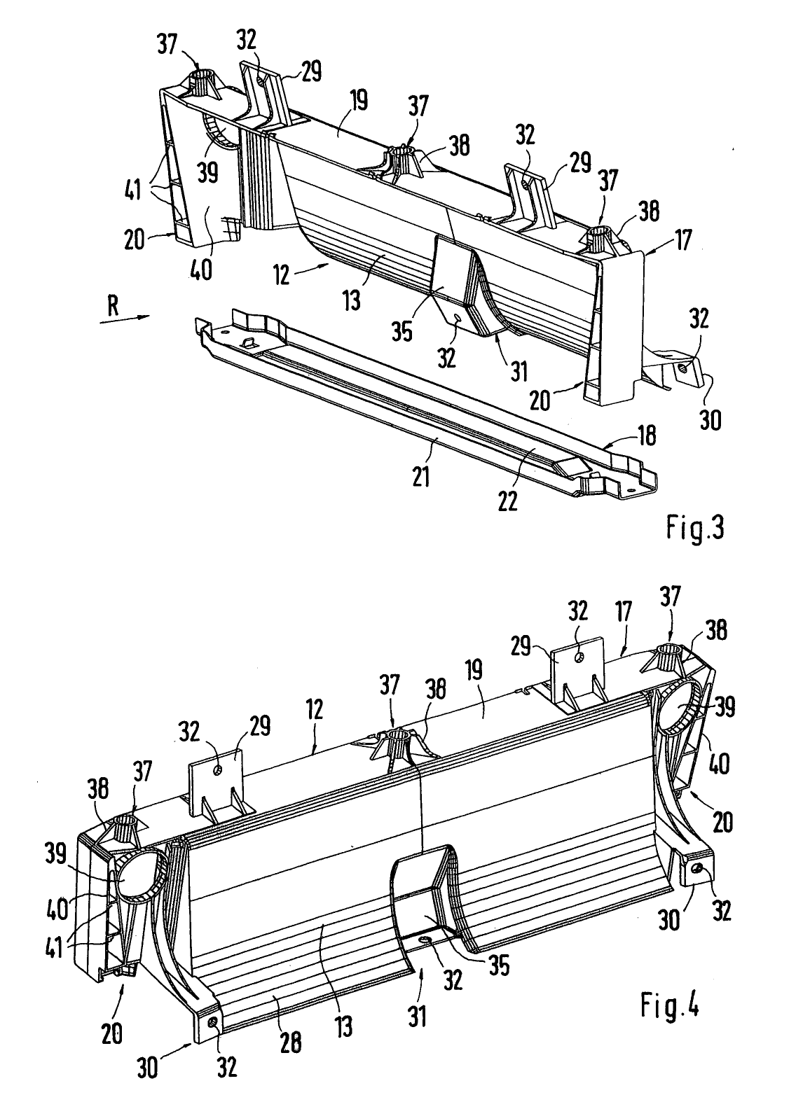

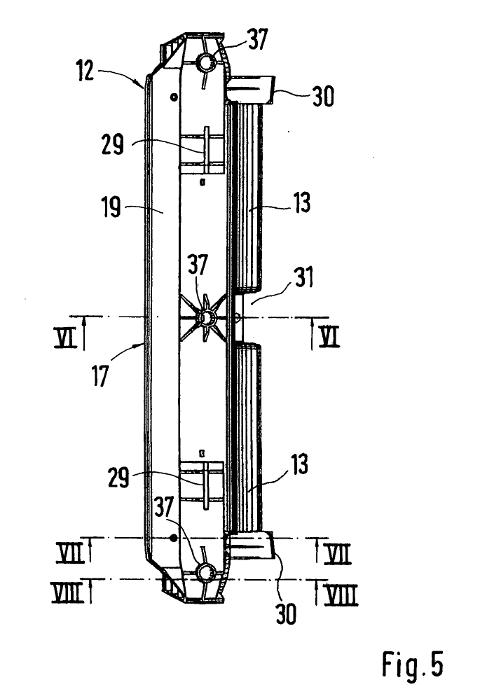

The at least one radiator 9 is accommodated by a supporting frame 12 which is held in position on the adjoining body 2 by means of releasable fastening elements (for example, screws). The radiator is inserted from the front viewed in the direction of the arrow R into the supporting frame 12 (FIG. 3). According to the invention, an air guiding element 13 is constructed in one piece with the supporting frame 12, which air guiding element 13, together with the radiator 9, forms at least one of the two air guiding ducts 10, 11.

In the embodiment shown, the air guiding element 13 connected with the supporting frame 12, together with the rearward side 14 of the radiator 9, forms the second air guiding duct 11, which is connected on the output side and which has a cooling-air outlet opening 16 on the side facing a road 15.

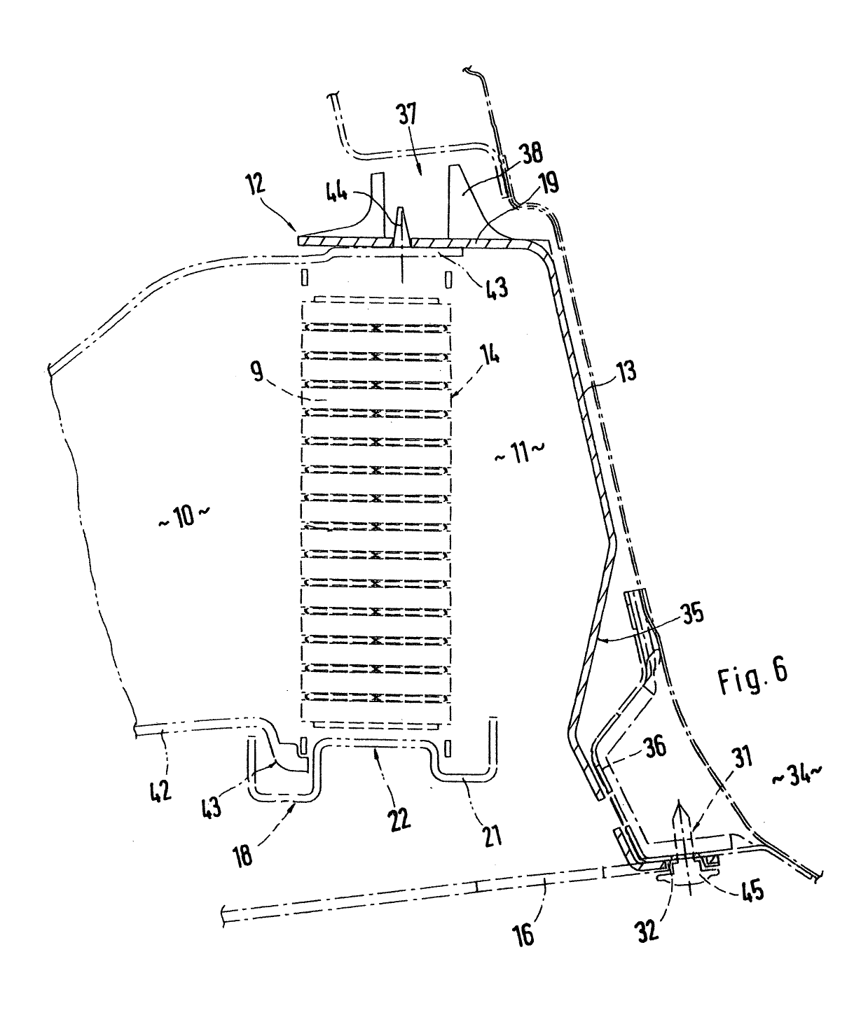

The supporting frame 12 is composed of a frame-shaped top part 17 and of a transversely extending bottom part 18, which is profiled in a rail shape. The air guiding element 13 is constructed in one piece with the top part 17 of the supporting frame 12 such that the transversely extending air guiding element 13 is connected to both exterior side cheeks 20 and to the upper cross member 19. The frame-shaped top part 17 is produced of a light-metal diecasting or of a suitable plastic material, such as PP GF30, PA 6.6, or the like. The profiled rail-shaped bottom part 18 of the supporting frame 12 consists of steel plate or aluminum sheet metal. The bottom part 18 has an approximately U-shaped cross-sectional shape which is open toward the top, in which case, a U-shaped bead 22, which is open toward the bottom, is provided in a significant partial region of the transverse dimension of the center piece 21 (FIG. 6).

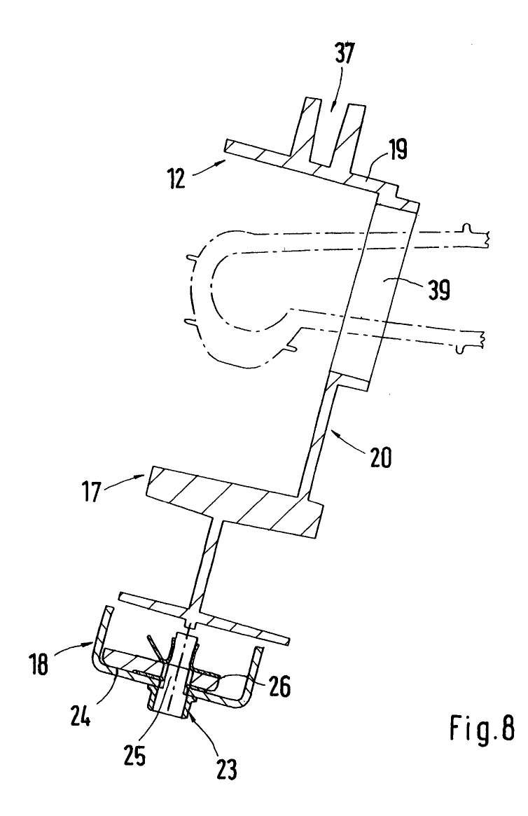

The frame-shaped top part 17 is placed on the bottom part 18 of the supporting frame 12, which are mutually connected by means of screwable fastening elements 23 arranged in the bottom area of the side cheeks 20 (FIG. 8).

In their lower end regions, the side cheeks 20 have contact surfaces 24 with one passage bore 25 respectively, in which case, a nut 26 or a holding clamp with a nut is arranged adjacent to the passage bore 25. The screwable fastening elements 23 are guided from below through openings of the bottom part 18 and are screwed into the nut 26 of the top part 17 (FIG. 8).

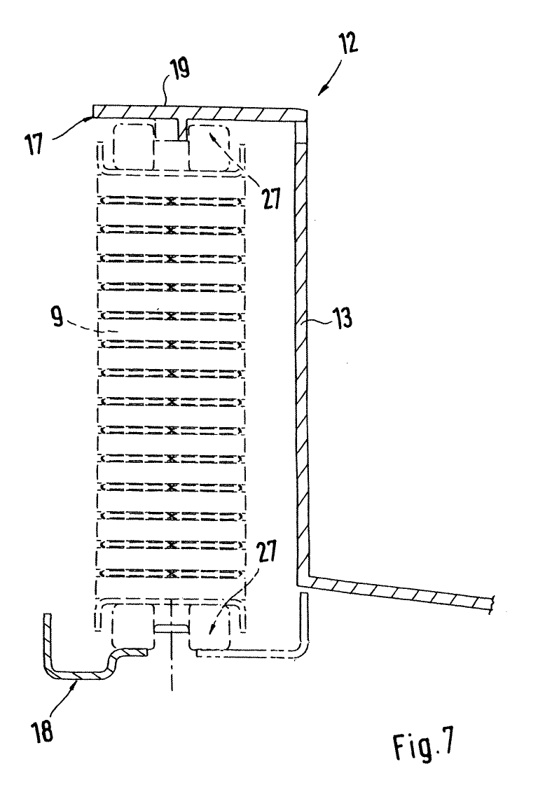

The radiator 9 is floatingly accommodated in the supporting frame 12 (FIG. 7). For this purpose, two elastic elements 27 respectively are provided at the bottom side and at the top side of the radiator 9, which elastic elements 17 extend between the radiator 9 and the supporting frame 12. The elastic elements 27 are fixed in their position at the radiator 9 as well as at the supporting frame 12 by means of devices, which are not shown in detail.

The air guiding element 13, on the one hand, reinforces the supporting frame 12 and, on the other hand, together with the radiator 9, forms the second air guiding duct 11. According to FIG. 2, the transversely extending air guiding element 13 is pulled farther downward than the bottom part 18 of the supporting frame 12, and has a rearwardly bent lower end region 28, which ends adjacent to the bottom-side air outlet opening 16.

On the top side of the cross member 19, in the region of both side cheeks 20 as well as in a lower center region of the air guiding element 13, fastening links 29, 30, 31 are constructed, each of these fastening links 29, 30, 31 having a passage opening 32 for a fastening screw 45 to be guided through.

The two spaced fastening links 29 are constructed on the top side of the cross member 19 and, in their mounted position, are supported on the exterior side of a body-side member 33. The two fastening links 30, which are provided in the regions of the side cheeks 20, extend on both sides of the air guiding duct 11 and are fixed to the adjacent trunk/engine space recess 34 situated behind.

The central fastening link 31 is formed by a bead-type depression 35 in a lower region of the air guiding element 13, which is supported on a placed-on part 36 of the trunk recess 34. In the embodiment shown, locally molded-on hollow-cylindrical domes 37 are provided for a stiffening on the top side of the cross member 19, which hollow-cylindrical domes 37 are in addition connected to the cross member 19 by way of exterior, radially extending supporting ribs 38. In the area of both side cheeks 20, locally circular receiving devices 39 are provided for guiding through radiator-side connection pieces not shown in detail.

The two side cheeks 20 have approximately triangular-shaped supporting sections 40 on their exterior sides, which supporting sections 40 are reinforced by webs 41 arranged above one another (FIG. 3).

In the embodiment shown, the air guiding duct 10 arranged on the input side is formed by a separately produced, closed air guiding housing 42 made of plastic, which is connected in the front to the cooling-air inlet opening 8 of the covering part 7. The rearward set-off edge 43 of the air guiding housing 42 is, in sections, inserted into the profiled bottom part 18 and the top part 17 of the supporting frame 12 and is fixed, for example, by means of holding pins 44 (see FIG. 6).

By means of the arrangement of intermediate pieces, which are not shown in detail, between the top part 17 and the bottom part 18 of the supporting frame 12, radiators 9 of different heights can be accommodated in the supporting frame 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

In the claims:

1. Motor vehicle having at least one radiator which, on an air input side, has a first air guiding duct with a cooling-air inlet opening and, on an air output side, has a second air guiding duct with a cooling-air outlet opening,
wherein at least one radiator is accommodated in a supporting frame fastened to an adjoining body, and wherein an air guiding element is constructed in one piece with the supporting frame, which air guiding element, together with the radiator, forms at least one of the first and second air guiding ducts.

2. Motor vehicle according to claim 1, wherein the air guiding element connected with the supporting frame, together with a rearward side of the radiator, forms the second air guiding duct connected on the output side.

3. Motor vehicle according to claim 1, wherein the supporting frame is composed of a frame-shaped top part and a transversely extending bottom part profiled in a rail shape.

4. Motor vehicle according to claim 3, wherein the top part comprises an upper cross member and two upright, downward-projecting exterior side cheeks.

5. Motor vehicle according to claim 4, wherein the air guiding element is constructed in one piece with the top part of the supporting frame such that the transversely extending air guiding element is connected to both exterior side cheeks and to a rearward edge of the upper cross member.

6. Motor vehicle according to claim 3, wherein the top part is made of a suitable plastic material, such as PP GF30, PA 6.6, or the like.

7. Motor vehicle according to claim 4, wherein the top part is made of a suitable plastic material, such as PP GF30, PA 6.6, or the like.

8. Motor vehicle according to claim 5, wherein the top part is made of a suitable plastic material, such as PP GF30, PA 6.6, or the like.

9. Motor vehicle according to claim 3, wherein the top part is made of a light metal diecasting.

10. Motor vehicle according to claim 4, wherein the top part is made of a light metal diecasting.

11. Motor vehicle according to claim 5, wherein the top part is made of a light metal diecasting.

12. Motor vehicle according to claim 3, wherein the bottom part of the supporting frame is made of steel plate or aluminum sheet metal.

13. Motor vehicle according to claim 4, wherein the bottom part of the supporting frame is made of steel plate or aluminum sheet metal

14. Motor vehicle according to claim 5, wherein the bottom part of the supporting frame is made of steel plate or aluminum sheet metal.

15. Motor vehicle according to claim 6, wherein the bottom part of the supporting frame is made of steel plate or aluminum sheet metal.

16. Motor vehicle according to claim 9, wherein the bottom part of the supporting frame is made of steel plate or aluminum sheet metal.

17. Motor vehicle according to claim 3, wherein fastening links for the body-side holding of the supporting frame are constructed on the top part.

18. Motor vehicle according to claim 4, wherein fastening links for the body-side holding of the supporting frame are constructed on the top part.

19. Motor vehicle according to claim 5, wherein fastening links for the body-side holding of the supporting frame are constructed on the top part.

20. Motor vehicle according to claim 3, wherein as a result of the arrangement of intermediate pieces between the top part and the bottom part, radiators of different heights can be accommodated in the supporting frame.

21. Motor vehicle according to claim 5, wherein as a result of the arrangement of intermediate pieces between the top part and the bottom part, radiators of different heights can be accommodated in the supporting frame.

22. A radiator assembly for a motor vehicle comprising:
a radiator,
an air inlet guiding duct at a first side of the radiator,
an air outlet guiding duct at a second side of the radiator, and
a supporting frame for the radiator, which supporting frame is fastenable to vehicle body parts,
wherein an air guiding element is constructed in one piece with the supporting frame, which air guiding element, together with the radiator, forms at least one of the first and second air guiding ducts.

23. A radiator assembly according to claim 22, wherein the air guiding element connected with the supporting frame, together with a rearward side of the radiator, forms the second air guiding duct connected on the output side.

24. A radiator assembly according to claim 22, wherein the supporting frame is composed of a frame-shaped top part and a transversely extending bottom part profiled in a rail shape.

25. A radiator assembly according to claim 24, wherein the top part comprises an upper cross member and two upright, downward-projecting extension side cheeks.

26. A radiator assembly according to claim 25, wherein the air guiding element is constructed in one piece with the top part of the supporting frame such that the transversely extending air guiding element is connected to both exterior side cheeks and to a rearward edge of the upper cross member.

27. A radiator assembly according to claim 26, wherein fastening links for the body-side holding of the supporting frame are constructed on the top part.

28. A method of making a radiator assembly for a motor vehicle which includes:
a radiator,
an air inlet guiding duct at a first side of the radiator,
an air outlet guiding duct at a second side of the radiator, and
a supporting frame for the radiator, which supporting frame is fastenable to vehicle body parts,
wherein an air guiding element is constructed in one piece with the supporting frame, which air guiding element, together with the radiator, forms at least one of the first and second air guiding ducts,
said method comprising:
connecting said supporting frame to adjoining vehicle body parts,
inserting said radiator into said supporting frame from aside of said radiator facing away from the air guiding element, and
attaching the supporting frame and radiator together.

29. A method according to claim 28, wherein the supporting frame is composed of a frame-shaped top part and a transversely extending bottom part profiled in a rail shape.

30. A method according to claim 29, wherein the top part comprises an upper cross member and two upright, downward-projecting extension side cheeks.

31. A method according to claim 30, wherein the air guiding element is constructed in one piece with the top part of the supporting frame such that the transversely extending air guiding element is connected to both exterior side cheeks and to a rearward edge of the upper cross member.

32. A method according to claim 31, wherein fastening links for the body-side holding of the supporting frame are constructed on the top part.

33. A method according to claim 29, wherein motor vehicle according to claim 5, wherein fastening links for the body-side holding of the supporting frame are constructed on the top part.
